(19) United States
(12) Patent Application Publication
(10) Pub. No.: US 2009/0031252 A1
(43) Pub. Date: Jan. 29, 2009

(54) Information processing apparatus, menu screen controlling method, and menu screen controlling program

(75) Inventor: Yoshiyuki Toda, Kanagawa (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 12/153,122

(22) Filed: May 14, 2008

(30) Foreign Application Priority Data
Jul. 25, 2007 (JP) 2007-193446

(51) Int. Cl. G06F 3/048

(52) U.S. Cl. 715/826

(57) ABSTRACT

An information processing apparatus, a menu screen controlling method, and a menu screen controlling program are disclosed; they are capable of easily updating a menu screen when a new function is added. In the method, a reading section installs a function program performing a prescribed function and a button representing the function executed by the function program; a new ID representing a layout position on a menu screen where each function is selected is associated with the function program and the button; the associated ID, function program, and button are stored in a plug-in storage unit; each plug-in stored in the plug-in storage unit generates a menu screen based on the ID associated with the button to be laid out on the menu screen; and the generated menu screen is displayed.

### BACKGROUND OF THE INVENTION

1. Field of the Invention

The present invention generally relates to an information processing apparatus, a menu screen controlling method, and a menu screen controlling program.

2. Description of the Related Art

Conventionally, there have been generally known an information processing apparatus having various functions selectable from a menu screen on a display. However, such an information processing apparatus has a problem that whenever the function selectable from a menu screen is changed, a user needs to update the menu screen to correspond to the change of the function, and unfortunately the operation of such menu screen updating is cumbersome for most of the users.

To solve the problem, there is disclosed a display information generating apparatus capable of generating a menu screen in accordance with definition information defining display information to be displayed on the menu screen (see Japanese Patent Application Publication No. 2006-224093). In the display information generating apparatus, the menu screen can be updated by editing the definition information.

According to the technique described in the Patent Document 1, surely, a menu screen can be updated in response to a function that has been already installed in the apparatus. However, when a new function is added as, for example, a plug-in, a new menu screen corresponding to the new function cannot be generated because no definition information corresponding to the new function is generated.

### SUMMARY OF THE INVENTION

The present invention is made in light of the above problems and may provide an information processing apparatus, a menu screen controlling method, and a menu screen controlling program capable of easily updating a menu screen corresponding to a newly added function.

To solve the problem, according to a first aspect of the present invention, there is provided an information processing apparatus including a function storage unit storing an identifier, a function program, and an image, the identifier representing a layout position of a menu screen where each function can be selected, the function program performing a prescribed function, the image representing a function executed by the function program, and the identifier, the function program, and the image being associated with each other; an acquiring unit acquiring a pair of the function program and the image from the outside; a registering unit associating a new identifier with the function program and the image each acquired by the acquiring unit and registering the identifier, the function, and the image into the function storage unit; a generating unit generating a menu screen where the image stored in the function storage unit is laid out in accordance with the identifier associated with the image; and a display unit displaying the menu screen generated by the generating unit.

According to a second aspect of the present invention there is provided an information processing apparatus according to the first aspect, further including a receiving unit receiving the identifier associated with the image having been selected from the menu screen where the image is laid out; and a starting unit staring the function program associated with the identifier received by the receiving unit, the function program being stored in the function storage unit.

According to a third aspect of the present invention, there is provided an information processing apparatus according to the first or second aspect, further including a layout order changing unit changing a layout order of the images laid out on the menu screen; and a storage position changing unit changing the identifier associating with the function program and the image stored in the function storage unit in accordance with the layout order having been changed by the layout order changing unit.

According to a fourth aspect of the present invention, there is provided an information processing apparatus according to any one of the first through third aspects, further including an access right storage unit storing user identification information identifying a user using the information processing apparatus and a function program unusable for the user, the user identification information and the function program being associated with each other; and an access right verifying unit, upon receiving a request of access right verification from the generating unit, verifying an access right of the function program stored in the function storage unit based on the function program unusable for the user associated with the user identification information input and stored into the access right storage unit by the user, wherein the generating unit generates a menu screen where the unusable function program out of the function programs stored in the function storage unit is made unselectable in accordance with the verification result obtained by the access right verifying unit.

According to a fifth aspect of the present invention, there is provided an information processing apparatus according to the fourth aspect, wherein an access right storage unit stores the user identification information and an unusable prescribed function out of the function programs, the user identification information and the unusable prescribed function being associated with each other; an access right verifying unit, upon receiving a request of access right verification from the generating unit, verifies an access right of the prescribed function stored in the function storage unit based on the unusable prescribed function out of the function program associated with the user identification information input into the access right storage unit by a user; and the generating unit generates a menu screen where the unusable prescribed function out of the function programs stored in the function storage unit is made unselectable in accordance with the verification result obtained by the access right verifying unit.

According to a sixth aspect of the present invention, there is provided an information processing apparatus according to any one of the first through fifth aspects, wherein a function setting screen generated by executing the function program can be commonly used by plural function programs.

According to a seventh aspect of the present invention, there is provided an information processing apparatus according to any one of the first through sixth aspects, wherein the function program can be partially or totally replaced by a newly installed function program.

According to an eighth aspect of the present invention, there is provided a menu screen controlling method including an acquiring step of acquiring a pair of a function program and an image from the outside, the function program performing a prescribed function, the image representing a function executed by the function program; a registering step of associating a new identifier with the function program and the image acquired in the acquiring step, the identifier representing a layout position of a menu screen where each function can be selected, and registering the function program, the image, and the identifier into a function storage unit, the function program and the image being associated with the identifier; a generating step of generating a menu screen where the image stored in the function storage unit is laid out in accordance with the identifier associated with the image; and a displaying step of displaying the menu screen generated by the generating unit.

According to a ninth aspect of the present invention, there is provided a menu screen controlling method according to the eighth aspect, further including a receiving step of receiving the identifier associated with the image having been selected from the menu screen where the image is laid out; and a starting step of staring the function program associated with the identifier received in the receiving step, the function program being stored in the function storage unit.

According to a tenth aspect of the present invention, there is provided a menu screen controlling method according to the eighth or ninth aspect, further including a layout order changing step of changing a layout order of the images laid out on the menu screen; and a storage position changing step of changing the identifier associating with the function program and the image stored in the function storage unit in accordance with the layout order having been changed in the layout order changing step.

According to an eleventh aspect of the present invention, there is provided a menu screen controlling method according to any one of the eighth through tenth aspects, further including an access right verifying step of, upon receiving a request of access right verification from the generating step, verifying an access right of the function program stored in the function storage unit based on the function program unusable for the user associated with the user identification information input and stored into an access right storage unit by the user, the access right storage unit storing user identification information identifying a user using the information processing apparatus and a function program unusable for the user, the user identification information and the function program being associated with each other, wherein the generating step generates a menu screen where the unusable function program out of the function programs stored in the function storage unit is made unselectable in accordance with the verification result obtained in the access right verifying step.

According to a twelfth aspect of the present invention, there is provided a menu screen controlling method according to the eleventh aspect, wherein an access right verifying step, upon receiving a request of access right verification from the generating step, verifies an access right of the prescribed function stored in the function storage unit based on the unusable prescribed function out of the function program associated with the user identification information input into an access right storage unit by a user, the access right storage unit stores the user identification information identifying a user using the information processing apparatus and the unusable prescribed function out of the function program, the user identification information and the unusable prescribed function being associated with each other; and the generating step generates a menu screen where the unusable prescribed function out of the function programs stored in the function storage unit is made unselectable in accordance with the verification result obtained in the access right verifying step.

According to a thirteenth aspect of the present invention, there is provided a menu screen controlling program causing a computer to execute the menu screen controlling method according to any one of the eighth through twelfth aspects.

According to an embodiment of the present invention, the image representing the function program and the function are associated with the identifier, and when a menu screen is generated to be displayed, the image is laid out on the menu screen at the position represented by the identifier associated with the image. Because of the feature, advantageously, even when a new function is added, it is possible to easily generate a menu screen on which a new image associated with the new function is formed by associating a new identifier with the new program and the new image of the new function and storing the identifier, the program and the image.

### BRIEF DESCRIPTION OF THE DRAWINGS

Other objects, features, and advantages of the present invention will become more apparent from the following descriptions when read in conjunction with the accompanying drawings, in which:

FIG. 1 is a block diagram showing an exemplary configuration of a Multi Function Peripheral (MFP) according to a first embodiment of the present invention;

FIG. 2 is a table showing an example of registration information of a main screen;

FIG. 3 is a table showing an example of registration information of a category 1 screen plug-in;

FIG. 4 is block diagram showing an exemplary configuration of each screen;

FIG. 5 is a drawing showing an example of transition of screens displayed on an operations panel;

FIG. 6 is a table showing an example of registration information when a FAX function is added to the category 1 screen plug-in;

FIG. 7 is a block diagram showing an exemplary configuration of each screen when the FAX function is added;

FIG. 8 is a drawing showing an example of transition of screens displayed on an operations panel when the FAX function is added;

FIG. 9 is a sequence diagram showing an exemplary process of adding a function;

FIG. 10 is a sequence diagram showing an exemplary process of displaying a menu screen;

FIG. 11 is a sequence diagram showing an exemplary process of registering a menu screen when the MFP is booted;

FIG. 12 is a block diagram showing an exemplary configuration of each screen when a read setting screen plug-in is re-installed;

FIG. 13 is a drawing showing an example of transition of screens displayed on an operations panel when the read setting screen is updated;

FIG. 14 is a drawing showing an example of a menu screen for changing a layout order of the function buttons;

FIG. 15 is a drawing showing an example of changing the registration information of the menu screen when the layout order of the function buttons is changed;

FIG. 16 is a block diagram showing an exemplary hardware configuration of the MFP according to an embodiment of the present invention;

FIG. 17 is a block diagram showing an exemplary configuration of an MFP according to a second embodiment of the present invention;

FIG. 18 is a drawing showing an example of data configuration of an access right database; and

FIG. 19 is a sequence diagram showing exemplary operations of each section in an access right verifying process.

### DETAILED DESCRIPTION OF THE PREFERRED EMBODIMENTS

In the following, an information processing apparatus, a menu screen controlling method, and a menu screen controlling program according to exemplary embodiments of the present invention are described with reference to the accompanying drawings. It should be noted that the embodiments of the present invention are not limited to the embodiments described blow.

### First Embodiment

First, a so-called Multi Function Peripheral (hereinafter simply referred to as “MFP”) according to a first embodiment of the present invention is described. The MFP includes features of a copier, a facsimile (FAX) machine, a printer, a scanner, and a distributing function for distributing an input image (such as a draft image scanned by the scanner or an image obtained by the printer or the facsimile machine).

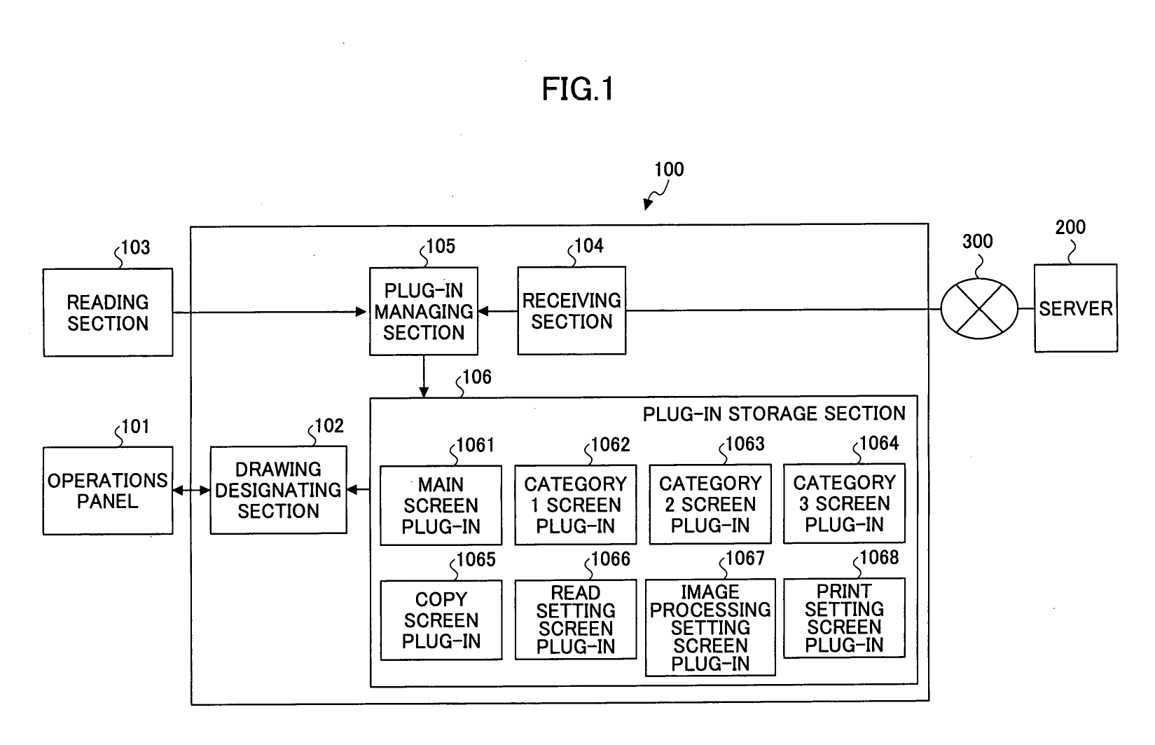

FIG. 1 is a block diagram showing an exemplary configuration of an MFP 100 according to the first embodiment of the present invention. The MFP 100 includes an operations panel 101, a drawing designating section 102, a reading section 103, a receiving section 104, a plug-in managing section 105, and a plug-in storage section 106.

The operations panel 101 displays a menu screen and a message designated by the drawing designating section 102. Further, the operations panel 101 acquires position data of the button selected by a user on a menu screen. Herein, the button refers to a Graphic User Interface (GUI) image on a menu screen for selecting a function to be started. It should be noted that in the descriptions of the embodiments of the present invention, buttons are used as an example of the GUI image for selecting a function. However, the GUI image according to an embodiment of the present invention is not limited to the buttons. Icons or any other GUI images may be used.

The drawing designating section 102 gives an instruction to the operations panel 101 to display a menu screen. Further, the drawing designating section 102 acquires an ID corresponding to a position of the button selected on a menu screen. It should be noted that the “ID” described herein constitutes an “identifier” according to the present invention.

The reading section 103 reads a function button and a function program stored in a portable storage medium as a pair of data items. Herein, the term “a function button” refers to a button representing a function of the MFP 100; and the term “a function program” refers to a program performing a prescribed function. It should be noted that the portable storage medium may be any medium including an SD memory card, a USB (universal Serial Bus) memory, or an IC (Integrated Circuit) card.

The receiving section 104 receives the function button and the function program as a pair of data items stored in a server 200 connected to a network 300 such as the Internet. It should be noted that “the reading section” or “the receiving section” described herein constitutes an “acquiring unit” according to the present invention.

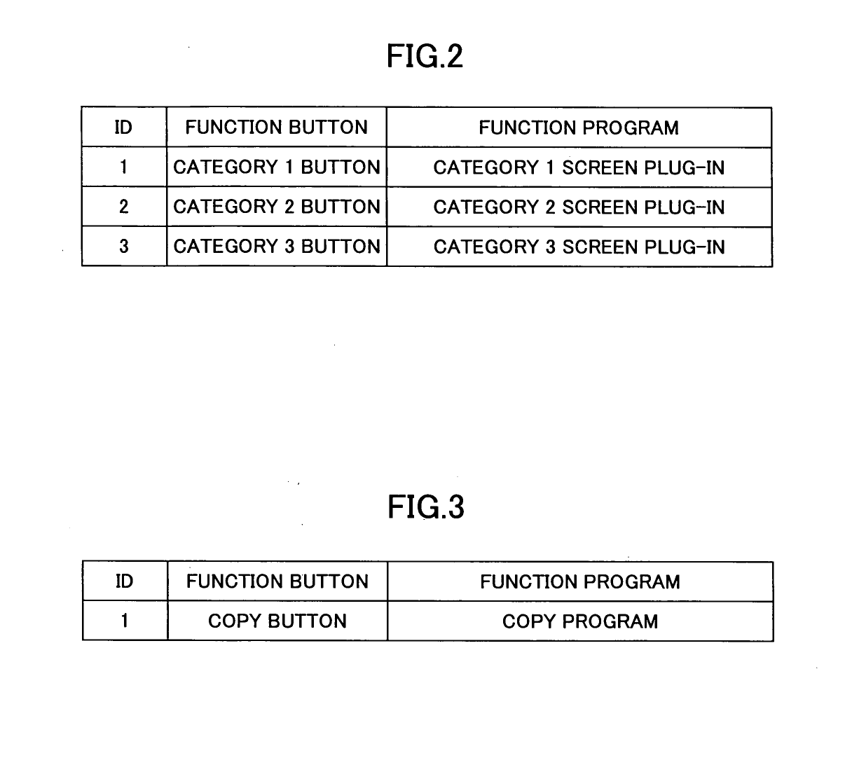

The plug-in storage section 106 stores plug-ins each for the corresponding menu screen. More specifically, as shown in FIG. 1, the plug-in storage section 106 includes a main screen plug-in 1061, a category 1 screen plug-in 1062, a category 2 screen plug-in 1063, a category 3 screen plug-in 1064, a copy screen plug-in 1065, a read setting screen plug-in 1066, an image processing setting screen plug-in 1067, and a print setting screen plug-in 1068. It should be noted that when a new function is installed, a new plug-in (for example, a FAX screen plug-in) corresponding to the new function is additionally stored in the plug-in storage section 106. Herein, the term “plug-in” includes a function button, a function program, and information associating the function button with the corresponding function program for displaying the menu screen (hereinafter the information is referred to as “registration information”). FIG. 2 is a table showing an example of the registration information of the main screen plug-in 1061. As shown in FIG. 2, the ID (identifier), the function button, and the function program are associated with each other and stored in the main screen plug-in 1061. For example, the “category 1 button” of the function button and “category 1 screen plug-in” of the function program are associated and registered with the ID “1”.

Further, as another example, the registration information of the category 1 screen plug-in is described. FIG. 3 is a table showing an example of registration information of the category 1 screen plug-in. As shown in FIG. 3, for example, a number “1”, “copy button”, and “copy program” are registered as the ID, the function button, and the function program, respectively. When receiving an instruction to display the category 1 screen from the drawing designating section 102, the category 1 screen plug-in 1062 places the “copy button” at the position where ID=1 on the category 1 screen and creates the category 1 screen. When the button at the position where ID=1 of the category 1 screen is pressed down, the category 1 screen plug-in 1062 starts the “copy program” to generate a copy screen and sends the generated copy screen to the drawing designating section 102 so that the copy screen is displayed.

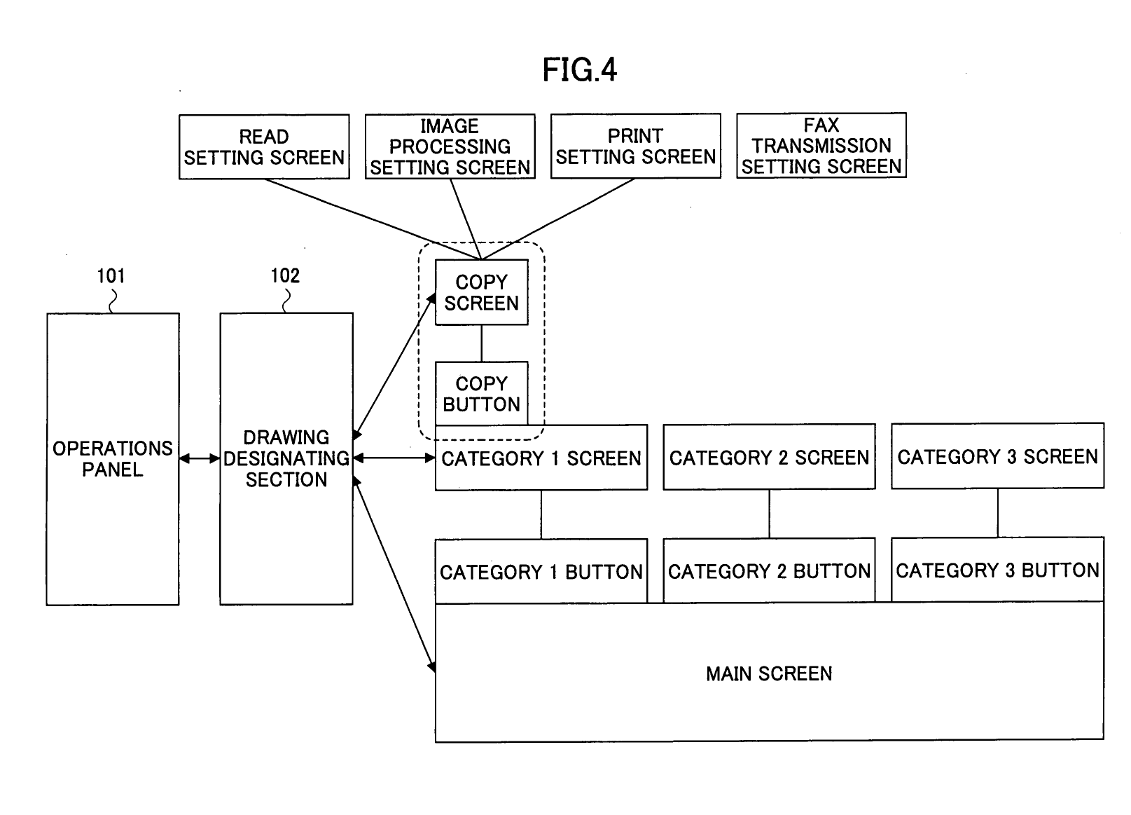

Next, a screen configuration based on the registration information as shown in FIGS. 2 and 3 is described. FIG. 4 shows an example of a configuration of each screen. As shown in FIG. 4, the category 1 button, the category 2 button, and the category 3 button are registered on the main screen and are associated with the category 1 screen, the category 2 screen, and the category 3 screen, respectively. Further, the copy button is registered in the category 1 screen, and the copy screen is associated with the copy button. The copy screen includes three screens: a read setting screen, an image processing setting screen, and a print setting screen, each independent of the others.

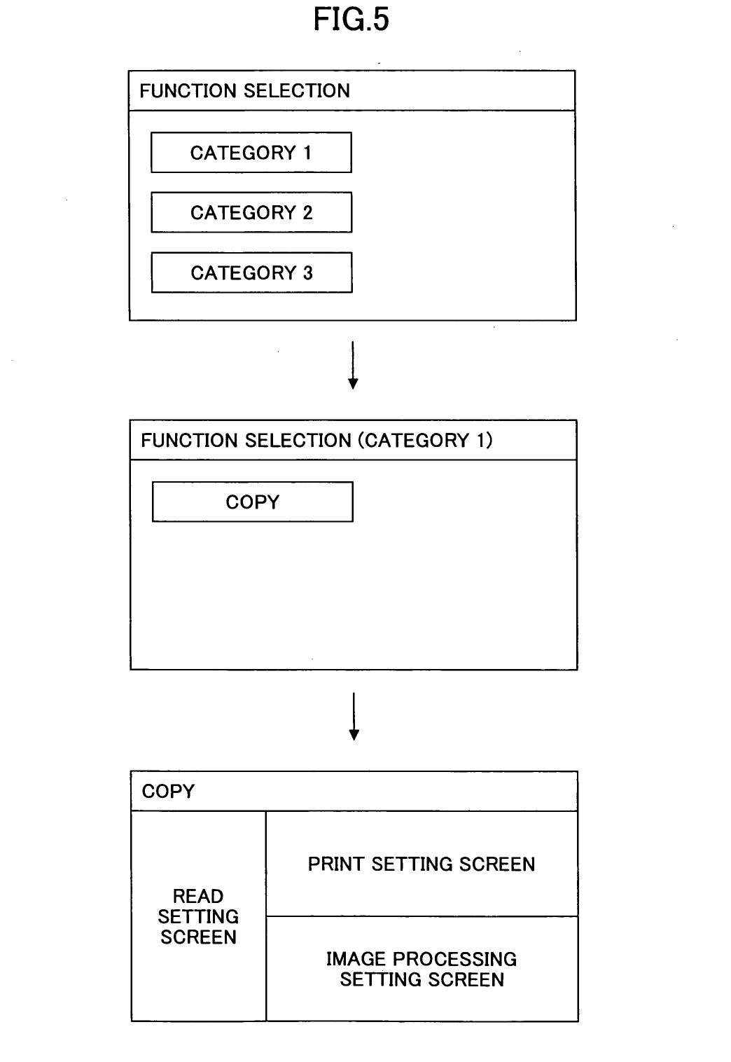

The transition of the above screens displayed on the operations panel 101 is described. FIG. 5 shows an example of transition of screens displayed on the operations panel 101. The upper side of FIG. 5 shows the main screen including a category 1 button, a category 2 button, and a category 3 button. When the category 1 button is pressed, the category 1 screen including the copy button is displayed. Then, when the copy button is pressed, the copy screen including the read setting screen, the image processing setting screen, and the print setting screen is displayed.

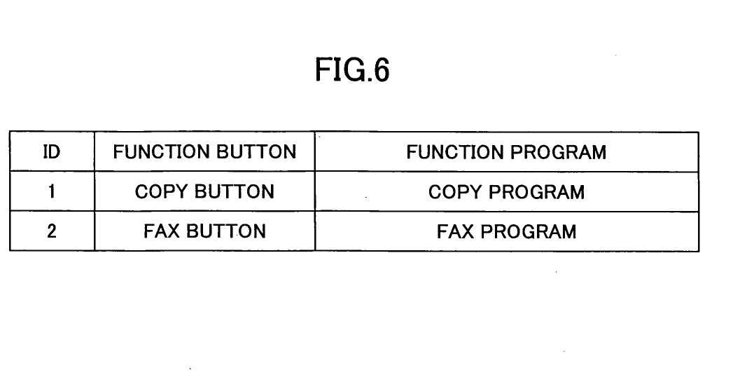

The plug-in managing section 105 registers the function button and the function program read by the reading section 103 or the function button and the function program received by the receiving section 104 into a plug-in stored in the plug-in storage section 106. FIG. 6 shows an example of registration information when the FAX function is added to the category 1 screen plug-in. For example, when a FAX button and a FAX program as a pair of data items that are read (or received) are registered into the category 1 screen plug-in, as shown in FIG. 6, a number “2” is newly allocated as the ID, and the “FAX” button and the “FAX program” are registered as the corresponding function button and the function program. When the category 1 screen is displayed after a new function button and a new function program are registered, for example, the category 1 screen on which the “copy” and “FAX” buttons are disposed at the position where ID=1 and ID=2, respectively is generated. In this manner, the category 1 screen is updated. When a user presses the “FAX” button on the screen, the “FAX program” is started.

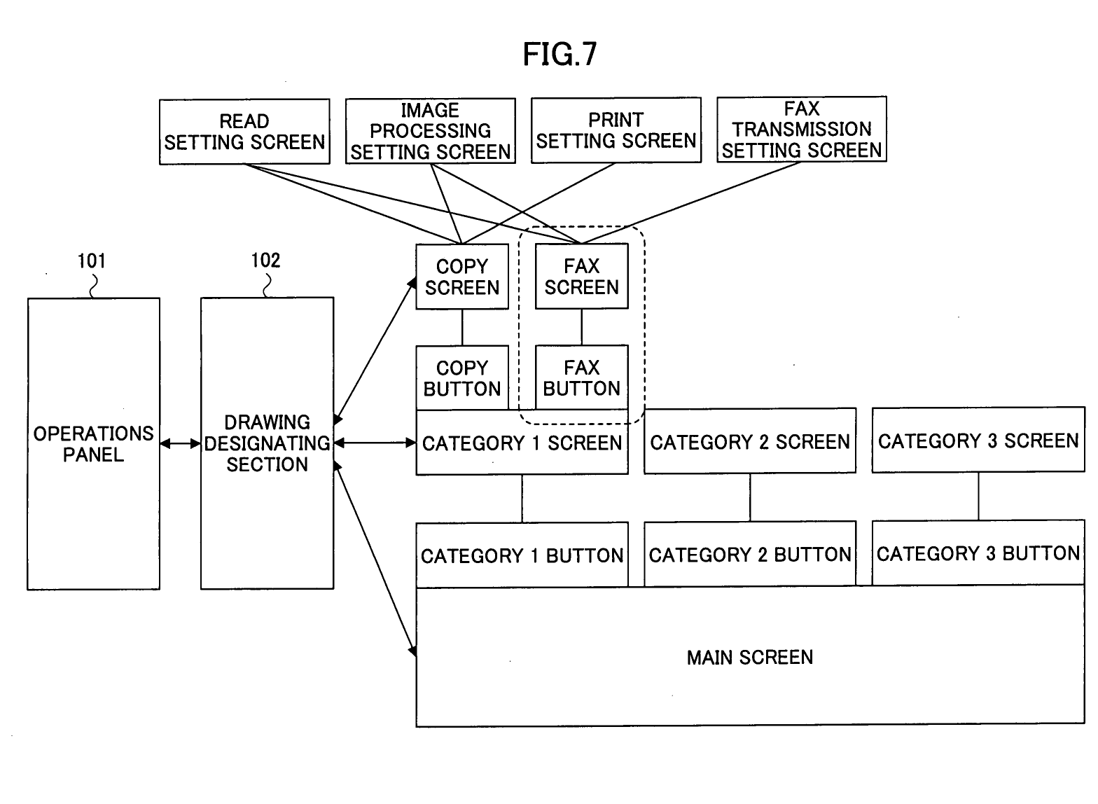

FIG. 7 shows an example of a screen configuration when the FAX function is added. As shown in FIG. 7, the FAX button is added to the category 1 screen, and the FAX screen is associated with the FAX button. The FAX screen includes the read setting screen, the image processing setting screen, and the FAX transmission setting screen. It should be noted that the read setting screen and the image processing setting screen used on the FAX screen are the same as those used on the copy screen.

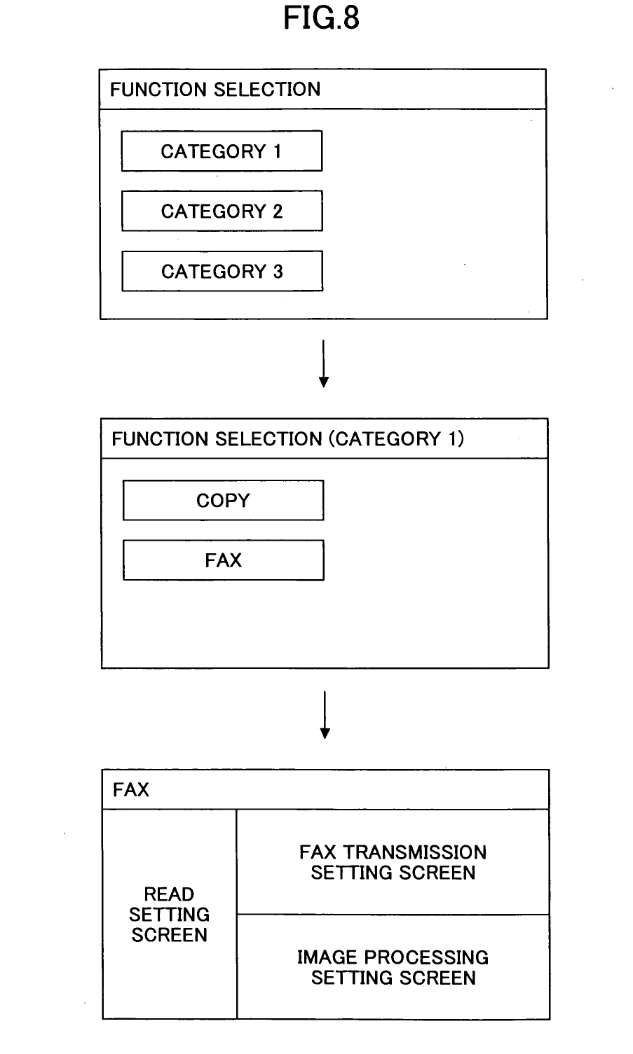

Further, the transition of screens displayed on the operations panel 101 when the FAX function is added is described. The upper side of FIG. 8 shows the main screen (unchanged) including a category 1 button, a category 2 button, and a category 3 button. When the category 1 button on the main screen is pressed, the category 1 screen is generated and displayed. The category 1 screen includes the copy button and the added FAX button. Then, when the FAX button is pressed, the FAX screen including the read setting screen, the image processing setting screen, and the FAX transmission setting screen is displayed.

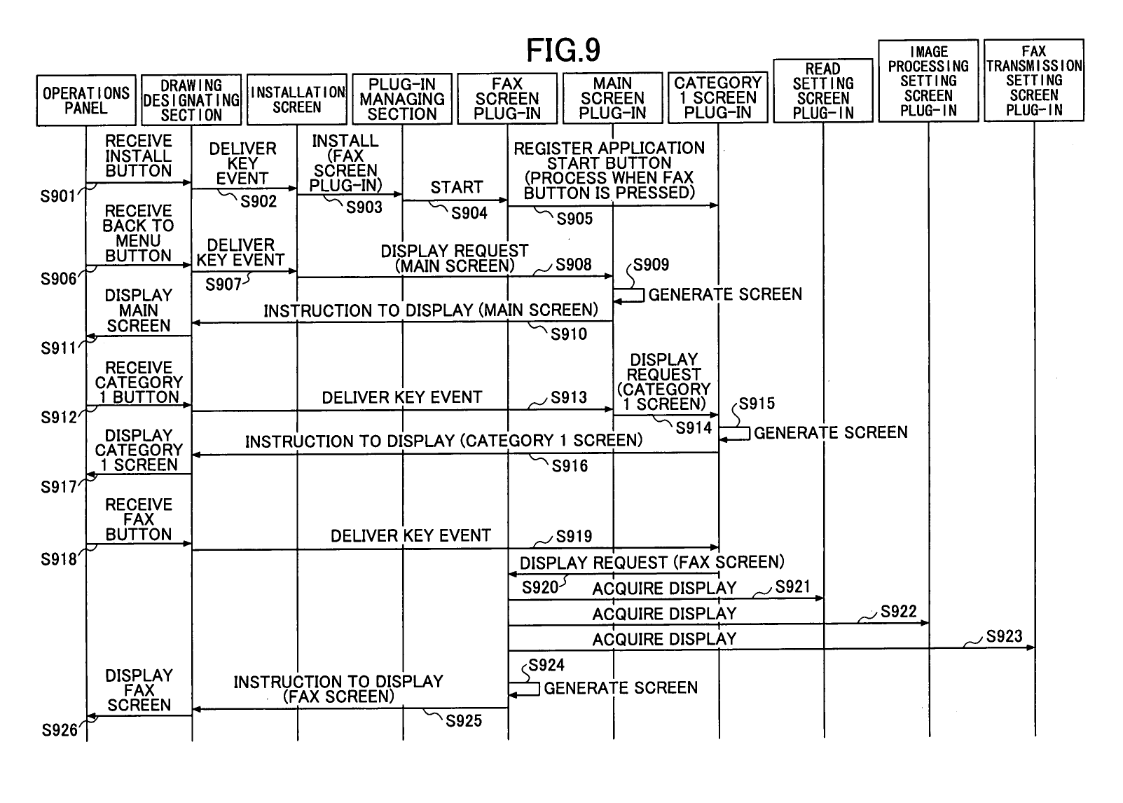

Next, a case where a new function is added to the MFP 100 having the above configuration is described. FIG. 9 is a sequence diagram showing an exemplary process of adding a new function. In this case, for example, the FAX function is added.

First, the drawing designating section 102 receives an instruction of installation from an installation screen displayed on the operations panel 101 (step S901). The drawing designating section 102 delivers a key event to the installation screen (step S902). The installation screen receives the key event and performs the installation of the FAX screen plug-in (step S903). Herein, the Fax screen plug-in includes the FAX button and the FAX program. It should be noted that the MFP 100 already has several category screens, and when a new plug-in is installed, one of the category screens can be selected as the category screen where the new plug-in is registered.

The plug-in managing section 105 starts the installed FAX screen plug-in (step S904). The FAX plug-in registers the FAX button and the FAX program in the category 1 screen (step S905). It should be noted that the FAX screen plug-in already has the information about which screen the FAX button and the FAX program are registered in based on the setting on the installation. As described above, when the FAX button and the FAX program are registered in the category 1 screen, a new ID corresponding to the FAX button and the FAX program is allocated and registered in the category 1 screen as shown in FIG. 6.

The drawing designating section 102 receives an instruction to go back to the installation screen menu (step S906). The drawing designating section 102 delivers a key event to the installation screen (step S907). The installation screen sends a display request to the main screen plug-in 1061 (step S908). The main screen plug-in 1061 generates the main screen based on the registration information of the main screen (step S909). Then, the main screen as shown in the upper side of FIG. 5 is generated in accordance with the registration information as shown in FIG. 2.

The main screen plug-in 1061 sends an instruction to the drawing designating section 102 to display the generated main screen (step S910). The drawing designating section 102 displays the main screen on the operations panel 101 (step S911).

The drawing designating section 102 receives a notice that the category 1 button on the main screen is selected (step S912). Then, the drawing designating section 102 acquires the ID corresponding to the selected button. Further, the drawing designating section 102 delivers a key event to the main screen plug-in 1061 (step S913). The main screen plug-in 1061 sends a display request to the category 1 screen plug-in 1062 corresponding to the acquired ID in the main screen (step S914). The category 1 screen plug-in 1062 generates the category 1 screen based on the registration information of the category 1 screen (step S915). Then, the category 1 screen as shown in the middle of FIG. 8 is generated based on the registration information shown in FIG. 6. In this case, since the FAX function is registered in step S905, the category 1 screen including the added FAX button is generated.

The category 1 screen plug-in 1062 sends an instruction to the drawing designating section 102 to display the category 1 screen (step S916). The drawing designating section 102 displays the category 1 screen (step S917).

The drawing designating section 102 receives a notice that the FAX button on the category 1 screen is selected (step S918). Then, the drawing designating section 102 acquires the ID corresponding to the selected button. Further, the drawing designating section 102 delivers a key event to category 1 screen plug-in 1062 (step S919). The category 1 screen plug-in 1062 sends a display request to the FAX screen plug-in corresponding to the acquired ID in the category 1 screen (step S920). The FAX screen plug-in starts the registered FAX program. That is, the FAX screen plug-in acquires the read setting screen (step S921), the image processing setting screen (step S922), and the FAX transmission setting screen (step S923). The FAX screen plug-in generates the FAX screen from the acquired the read setting screen, the image processing setting screen, and the FAX transmission setting screen (step S924).

The FAX screen plug-in sends an instruction to the drawing designating section 102 to display the generated FAX screen (step S925). The drawing designating section 102 displays the FAX screen on the operations panel 101 (step S926).

As described above, when a new function is installed, the function button and the function program of the new function are registered with respect to the screen displaying the function button, and the menu screen in accordance with the registration information is generated. As a result, simply by installing a new function, the menu screen is accordingly updated and the new function can be started from the updated menu screen.

Further, when the function button is selected from the menu screen, the ID corresponding to the button selected by a user is acquired, and a function program corresponding to the acquired ID is started. Because of the configuration, it is not necessary to add the function program to the menu screen, thereby facilitating the updating of the menu screen.

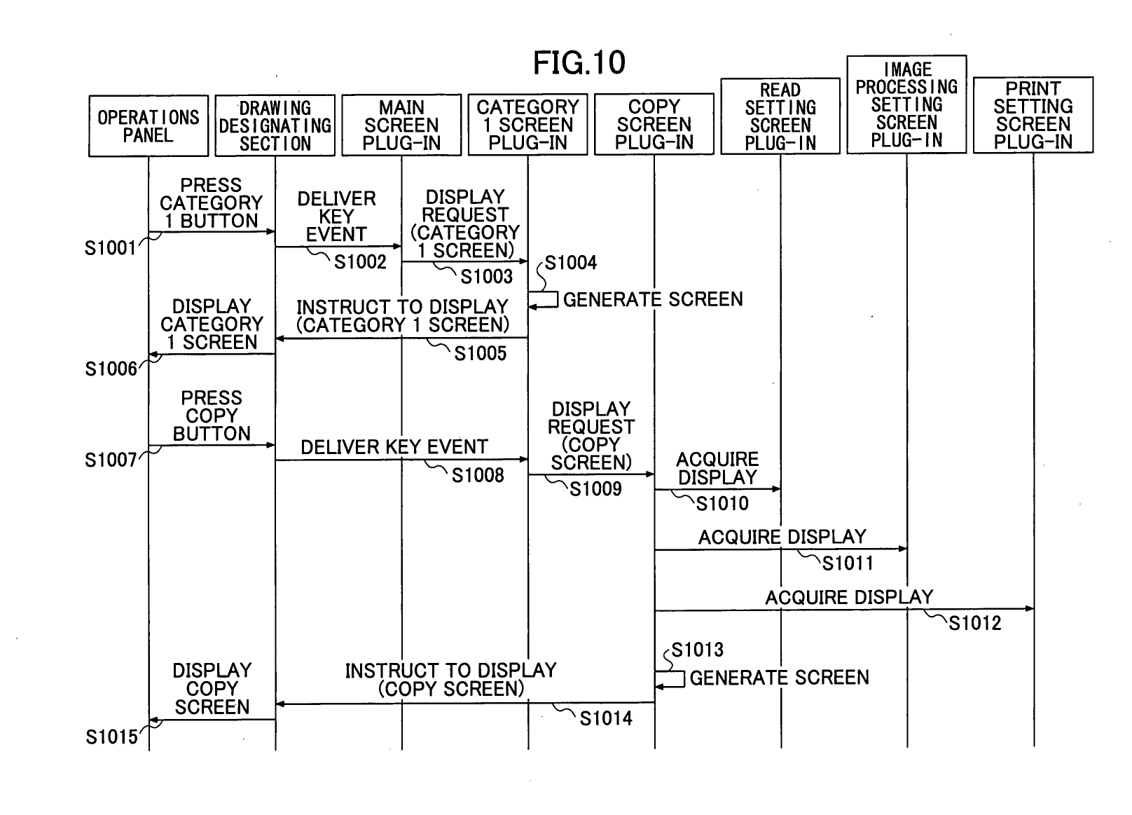

Next, a process of displaying the menu screen of the MFP 100 is described. FIG. 10 is a sequence diagram showing an exemplary process of displaying the menu screen. In this example, the main screen, the category 1 screen, and the copy screen are sequentially displayed.

The drawing designating section 102 receives a notice that the category 1 button on the main screen is selected (step S1001). Then, the drawing designating section 102 acquires the ID corresponding to the selected button. Further, the drawing designating section 102 delivers a key event to the main screen plug-in 1061 (step S1002). The main screen plug-in 1061 sends a display request to the category 1 screen plug-in 1062 corresponding to the acquired ID in the main screen (step S1003). The category 1 screen plug-in 1062 generates the category 1 screen based on the registration information of the category 1 screen (step S1004).

The category 1 screen plug-in 1062 sends an instruction to the drawing designating section 102 to display the category 1 screen (step S1005). The drawing designating section 102 displays the category 1 screen (step S1006).

The drawing designating section 102 receives a notice that the copy button on the category 1 screen is selected (step S1007). Then, the drawing designating section 102 acquires the ID corresponding to the selected button. Further, the drawing designating section 102 delivers a key event to category 1 screen plug-in 1062 (step S1008). The category 1 screen plug-in 1062 sends a display request to the copy screen plug-in 1065 corresponding to the acquired ID in the category 1 screen (step S1009). The copy screen plug-in 1065 starts the registered copy program. That is, the copy screen plug-in 1065 acquires the read setting screen (step S1010), the image processing setting screen (step S1011), and the print setting screen (step S1012). The print screen plug-in 1065 generates the copy screen from the acquired read setting screen, the image processing setting screen, and the print setting screen (step S1013).

The copy screen plug-in 1065 sends an instruction to the drawing designating section 102 to display the generated copy screen (step S1014). The drawing designating section 102 displays the copy screen on the operations panel 101 (step S1015).

As described above, when a menu screen is to be displayed, the menu screen is generated in accordance with the registration information whenever a display request is issued and the generated menu screen is displayed.

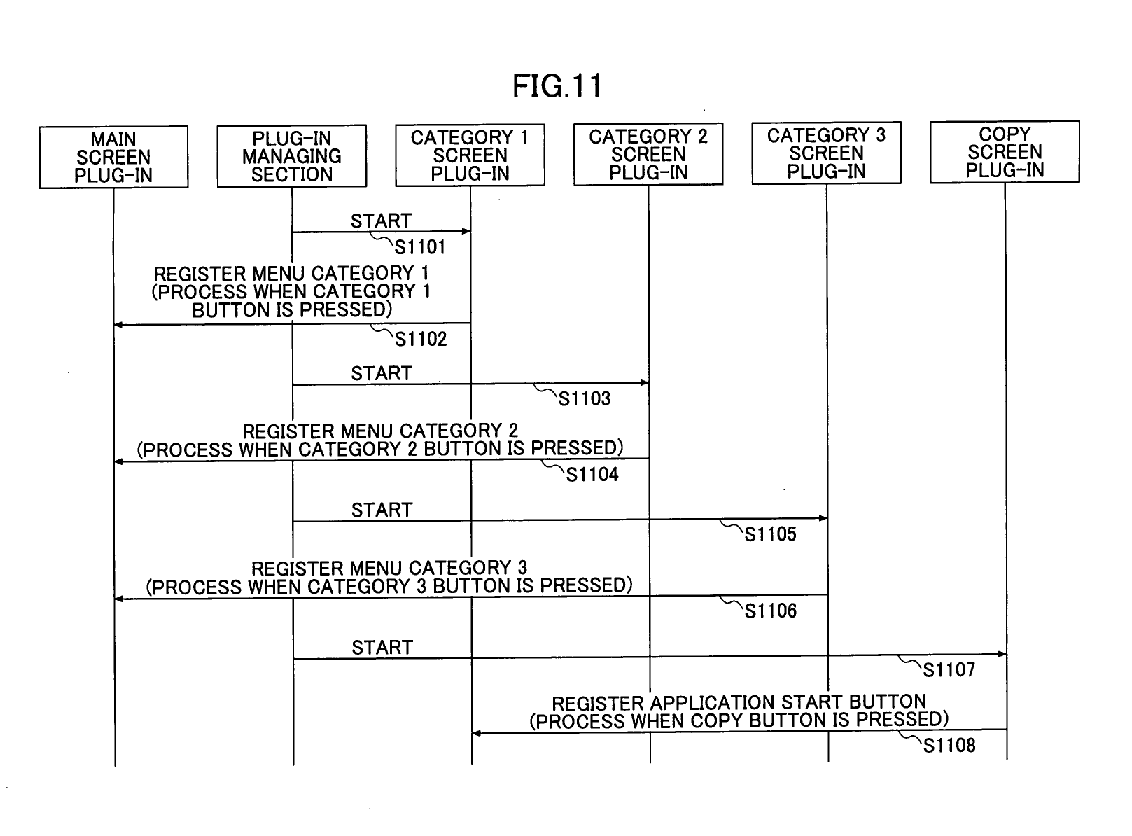

Next, a process of registering the menu screen when the MFP 100 is booted is described. FIG. 11 is a sequence diagram showing an exemplary process of registering the menu screen when the MFP 100 is booted. In this example, the main screen, the category 1 screen, the category 2 screen, the category 3 screen, and the copy screen are registered.

First, the plug-in managing section 105 starts the category 1 screen plug-in 1062 (step S1101). The category 1 screen plug-in 1062 registers the category 1 button and the category 1 screen plug-in 1062 in the main screen plug-in 1061 (step S1102). Next, the plug-in managing section 105 starts the category 2 screen plug-in 1063 (step S1103). The category 2 screen plug-in registers the category 2 button and the category 2 screen plug-in 1063 in the main screen plug-in 1061 (step S1104).

The plug-in managing section 105 starts the category 3 screen plug-in 1064 (step S1105). The category 3 screen plug-in 1064 registers the category 3 button and the category 3 screen plug-in 1064 in the main screen plug-in 1061 (step S1106). Up to this point, the data as shown in FIG. 2 are registered as the registration information of the main screen.

The plug-in managing section 105 starts the copy screen plug-in 1065 (step S1107). The copy screen plug-in 1065 registers the copy button and the copy plug-in 1065 in the category 1 screen plug-in 1062 (step S1108). As the registration information of the copy screen, the data as shown in FIG. 3 are registered.

As described above, the function button and the function program of a plug-in can be registered in a desired menu screen on which the function button of the plug-in is to be displayed upon the MFP 100 being booted. Because of the configuration, even when, for example, the scanner is removed, the HDD is replaced, or the software configuration such as the data in the HDD or the hardware configuration is updated when the power of the MFP 100 is turned OFF, it is possible to generate a new menu screen corresponding to the updated configuration of the software and the hardware by initializing and re-registering the function button and the function program in the menu screen whenever the MFP 100 is booted.

In the above embodiment of the present invention, an example is described where the function button and the function program are registered in each menu screen whenever the MFP 100 is booted. However, the embodiment of the present invention is not limited to this example. For example, the associations among the ID, the function key, and the function program for each menu screen that have been once registered may be stored as the registration information in a storage unit, and a menu screen may be generated and displayed by reading the registration information in the storage unit.

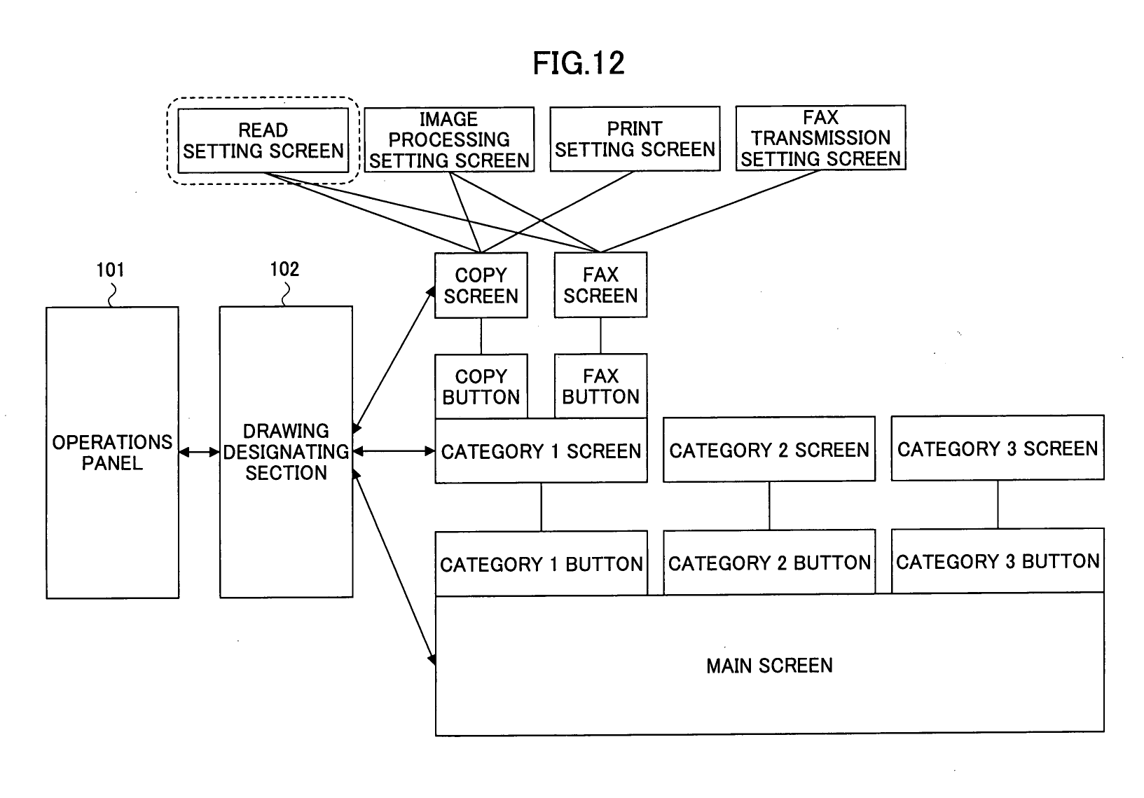

Further, advantages of a configuration according to an embodiment of the present invention are further described. FIG. 12 shows an example of a screen configuration when a read setting screen plug-in is re-installed. As shown in FIG. 12, the read setting screen in a dotted line is associated with both the copy screen and the FAX screen. Therefore, even when the read setting screen plug-in is totally or partially replaced (updated) by a new read setting screen plug-in having an additional function, both the copy screen and the FAX screen are associated with the new read setting screen generated by the replaced read setting plug-in. Namely, when the copy screen and the FAX screen are generated, the copy screen and the FAX screen are generated based on the replaced new read setting screen.

Still further, the read setting plug-in may be replaced by a plug-in having another function. For example, when the copy screen plug-in is totally replaced by the FAX screen plug-in, the FAX screen is generated instead of the copy screen.

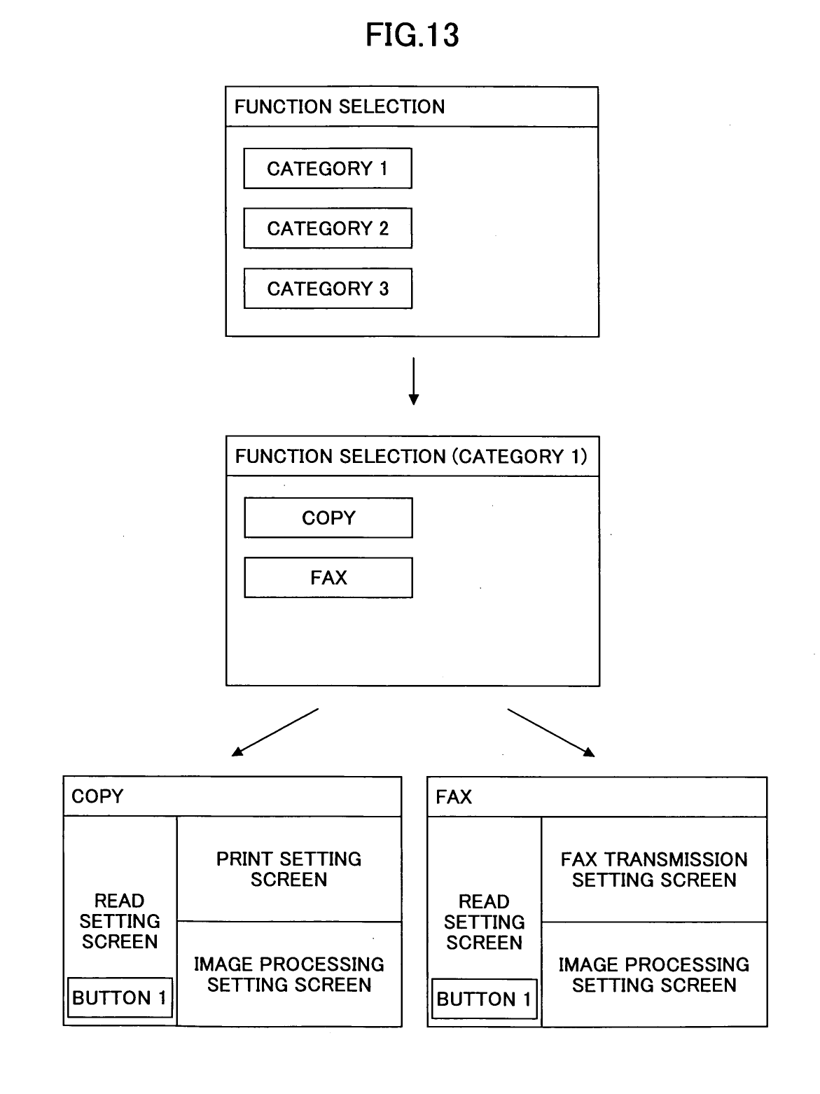

Next, the transition of the screens displayed on the operations panel 101 after the read setting screen is updated is described. FIG. 13 shows an example of transition of the screens after the read setting screen is updated. The upper side of FIG. 13 shows the main screen (unchanged) including a category 1 button, a category 2 button, and a category 3 button. When the category 1 button on the main screen is pressed, the category 1 screen is displayed. The category 1 screen includes the copy button and the FAX button. Then, when the copy button is pressed, the copy screen including the read setting screen including the button 1 is displayed. In the same manner, when the FAX button on the category 1 screen is pressed, the FAX screen including the read setting screen including the button 1 is displayed.

As described above, when a screen commonly used by plural menu screens is updated by adding a new screen, the updated new screen can be commonly displayed in each of the plural menu screens. More specifically, when the read setting screen commonly used by both the copy screen and the FAX screen is updated by adding a new read setting screen, the new updated read setting screen can be commonly displayed in each of the copy screen and the FAX screen.

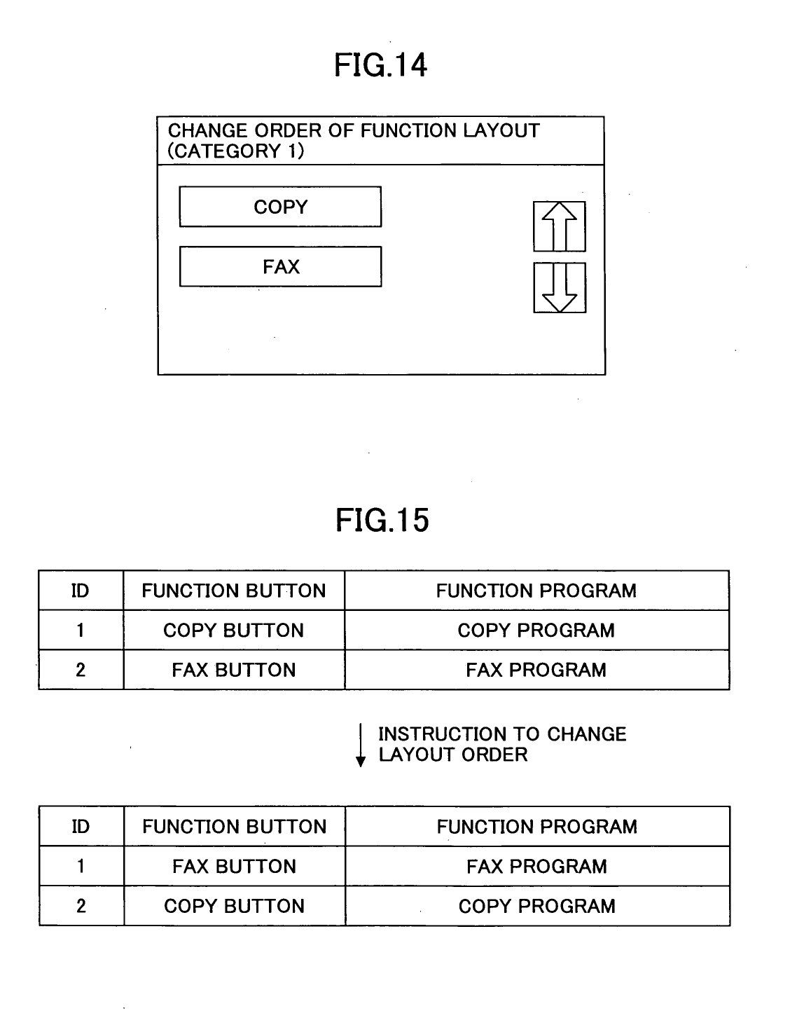

Further, in the above embodiment of the present invention, the buttons on the menu screen are arranged according to the registered order of the buttons. However, it is convenient if the more frequently used buttons can be arranged in higher positions in the menu screens. FIG. 14 shows an example of a menu screen for changing the order of the buttons. As shown in FIG. 14, the category 1 menu includes the copy button and the FAX button arranged according to the registered order, and an upper arrow key and a lower arrow key. For example, when the copy button and the lower arrow key are sequentially pressed, the order of buttons on the category 1 menu can be accordingly changed.

FIG. 15 shows an example when the order of registration information for a menu screen is changed due to the operation for changing the order. As shown in FIG. 15, when the above instruction to change the order of arranging the buttons on the menu screen is issued, the original registration information is updated by new registration information according to the instruction. By using this function, it becomes possible to change the layout order of the function buttons on the menu screen and to start the function program corresponding to the function button selected on the menu screen simply by changing the registration information of the menu screen. Therefore, it is possible to easily change the order of buttons on a menu screen.

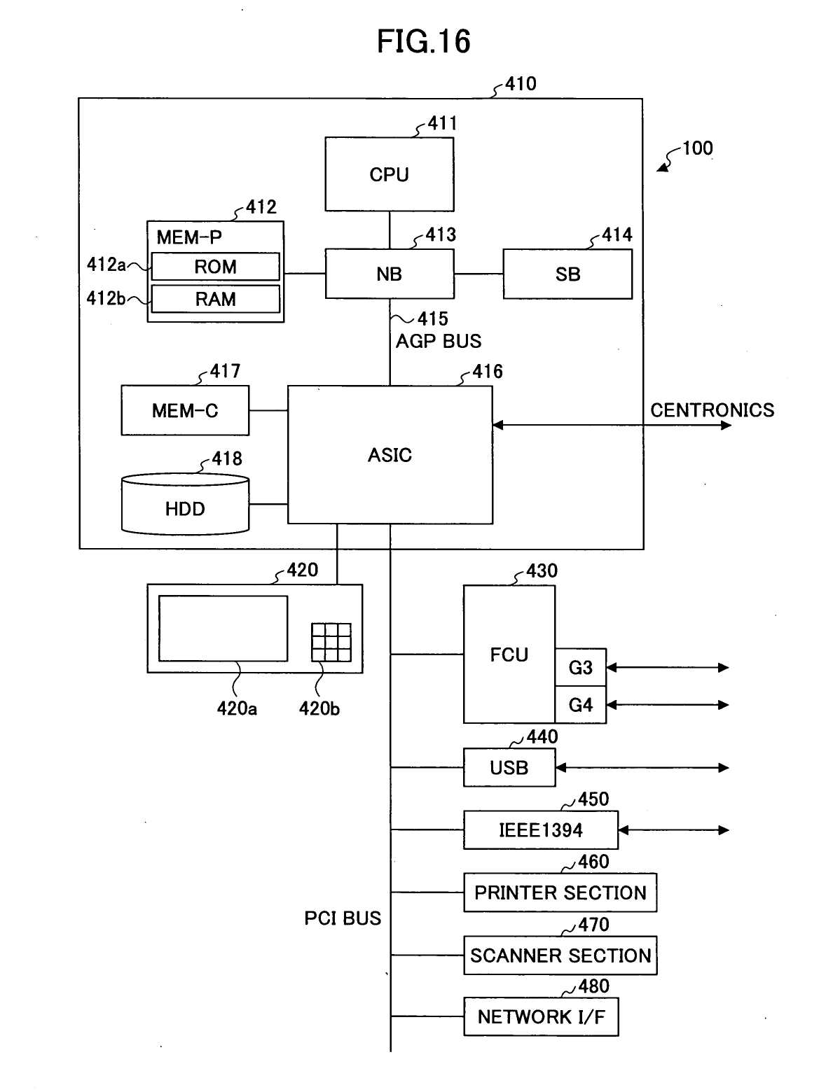

FIG. 16 shows an example of a hardware configuration of the MFP 100 according to an embodiment of the present invention. As shown in FIG. 16, the digital MFP 100 includes a controller 410, a printer section 460, and a scanner section 470. Those controller 410, printer section 460, and scanner section 470 are connected with each other via a Peripheral Component Interconnect (PCI) Bus. The controller 410 controls all the operations in the digital MFP 100 including displaying operations and communicating operations and the operations input from an operations section 420 of the MFP 100. It should be noted that the image processing unit performing, for example, a gamma conversion process is included in the printer section 460 or the scanner section 470. The operations section 420 includes an operations display section 420a and a keyboard section 420b. The operations display section 420a displays, for example, image information of a draft sheet read by the scanner section 470 and receives operations input from a user through the touch panel provided on the operations display section 420a. The keyboard section 420b receives operations input by the user.

In the digital MFP 100 according to an embodiment of the present invention, a document box function, a copying function, a printer function, and a facsimile function can be sequentially selected. When the document box function is selected, the MFP 100 is set in the document box function mode. In the same manner, when the copying function, the printer function, and the facsimile function are selected, the MFP 100 is set in the copying function mode, the printer function mode, and the facsimile function mode, respectively.

The controller 410 includes a Central Processing Unit (CPU) 411, a system memory (MEM-P) 412, a north bridge (NB) 413, a south bridge (SB) 414, an Application Specific Integrated Circuit (ASIC) 416, a local memory (MEM-C) 417 serving as a storage unit, a Hard Disk Drive (HDD) 418 serving as another storage unit, and an Accelerated Graphics Port (AGP) bus 415 connecting the NB 413 and the ASIC 416. The MEM-P 412 includes a Read Only Memory (ROM) 412a and a Random Access Memory (RAM) 412b.

The CPU 411 controls the entire operation in the digital MFP 100 and is connected to other devices through a chipset including the NB 413, the MEM-P 412, and the SB 414.

The NB 413 provides connections among the CPU 411, the MEM-P 412, the SB 414 and-the AGP bus 415, and includes a memory controller for controlling read and write operations with respect to the MEM-P 412, a PCI master, and an AGP target.

The MEM-P 412 is used as a memory for storing and loading a program and data and drawing an image for a printer and includes the ROM 412a and the RAM 412b. The ROM 412a is a read only memory for storing programs and data for controlling the operations of the CPU 411. The RAM 412b is a random access memory for loading programs and data and drawing an image for a printer.

The SB 414 provides connections among the NB 413, PCI devices, and peripheral devices. The SB 414 is connected to the NB 413 via a PCI bus. Further, for example, a network interface (I/F) section 480 is connected to the PCI bus.

The ASIC 416 includes a hardware component for performing image processing and serves as a bridge providing connections among the AGP bus 415, the PCI bus, the HDD 418, and the MEM-P 417. The ASIC 416 includes a PCI target, an AGP master, an arbiter (ARB) as a core part of the ASIC 416, a memory controller for controlling the MEM-C 417, plural Direct Memory Access Controllers (DMACs) for, for example, rotating image data by hardware logic, and a PCI unit for data transmission between the printer section 460 and the scanner section 470 through the PCI bus. The ASIC 416 is connected to a Fax Control Unit (FCU) 430, a Universal serial Bus (USB) 440, the Institute of Electric and Electronics Engineers 1394 (IEEE 1394) interface 450 via the PCI bus.

The MEM-C 417 is a local memory used as an image buffer for the copier and a code buffer. The HDD 418 is a storage for storing image data, a program for controlling the operations of the CPU 411, font data, and form data.

The AGP bus 415 is a bus interface for a graphic accelerator card for accelerating graphic processes and accelerates the processing speed of the graphic accelerator card by directly accessing the MEM-P 412 with high throughput.

It should be noted that the menu screen control program executed by the MFP 100 according to an embodiment of the present invention is stored in, for example, the ROM in advance.

The menu screen control program executed in the MFP 100 according to an embodiment of the present invention may be stored in a computer-readable recording medium such as a CD-ROM, a Flexible Disk (FD), a CD-R, or a Digital Versatile Disk (DVD) in a format capable of being installed and executed.

Further, the menu screen control program executed in the MFP 100 according to an embodiment of the present invention may be stored in a computer connected to a network such as the Internet, and the menu screen control program may be provided by download over the network. Or, the menu screen control program executed in the MFP 100 according to an embodiment of the present invention may be provided or distributed over a network such as the Internet.

The menu screen control program executed in the MFP 100 according to an embodiment of the present invention is configured so as to have modules each corresponding to the sections including the reading section 103, the receiving section 104, the plug-in managing section 105, the drawing designating section 102, the main screen plug-in 1061, the category 1 screen plug-in 1062, the category 2 screen plug-in 1063, the category 3 screen plug-in 1064, the copy screen plug-in 1065, the FAX screen plug-in, the read setting screen plug-in 1066, the image processing setting screen plug-in 1067, and the print setting screen plug-in 1068. As a hardware of the MFP 100 according to an embodiment of the present invention, the CPU 411 loads the menu screen control program from the ROM 412a and executes the loaded menu screen control program so that each of the above modules is loaded onto the main memory to generates, for example, the reading section 103, the receiving section 104, the plug-in managing section 105, the drawing designating section 102, the main screen plug-in 1061, the category 1 screen plug-in 1062, the category 2 screen plug-in 1063, the category 3 screen plug-in 1064, the copy screen plug-in 1065, the FAX screen plug-in, the read setting screen plug-in 1066, the image processing setting screen plug-in 1067, and the print setting screen plug-in 1068 on the main memory.

In the above descriptions, the MFP according to an embodiment of the present invention is described. However, the embodiment of the present invention is not limited to the MFP, and the embodiment of the present invention may be applied to any information processing apparatus, such as a copier, a facsimile machine, and a printer, capable of executing a function selected from a displayed function button.

Further, in the above description, buttons are used as a GUI image to select a function. However, the embodiment of the present invention is not limited to the buttons. Various selecting methods of using, for example, an icon or a numeral key corresponding to a displayed function may be used.

### Second Embodiment

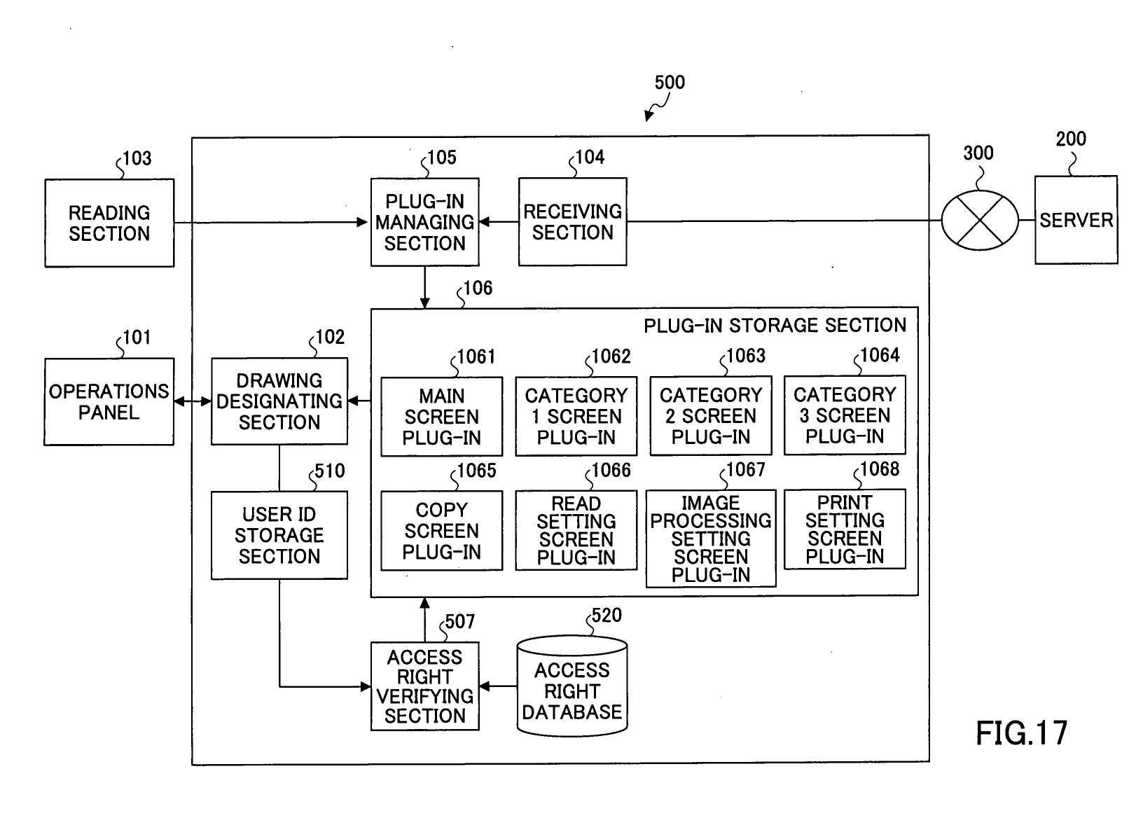

An MFP according to a second embodiment of the present invention is described with reference to the accompanying drawings. In the descriptions of the MFP according to the second embodiment of the present invention, only elements unique to the second embodiment are described, and the descriptions of the elements same as those in the first embodiment are omitted. FIG. 17 is a block diagram showing an exemplary configuration of an MFP 500 according to the second embodiment of the present invention.

The MFP 500 according to the second embodiment of the present invention includes the operations panel 101, the drawing designating section 102, the reading section 103, the receiving section 104, the plug-in managing section 105, the plug-in storage section 106, an access right verifying section 507, a user ID storage section 510, and an access right database 520. Herein, the descriptions of the configurations and the functions of the operations panel 101, the drawing designating section 102, the reading section 103, the receiving section 104, the plug-in managing section 105, and the plug-in storage section 106 are omitted due to their being the same configurations and functions as those in the first embodiment of the present invention.

The-user ID storage section 510 stores a user ID for identifying a user currently using the MFP 500 based on the user ID input through the operations panel by the user while the user uses the MFP 500.

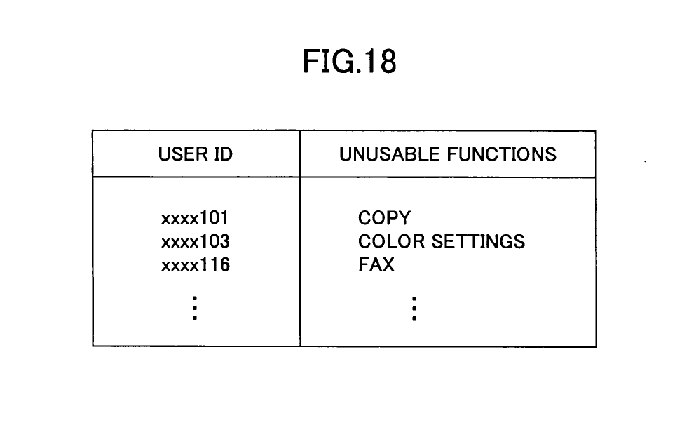

The access right database 520 stores usable or unusable functions for each user ID. FIG. 18 is a table showing an example of the data configuration of the access right database 520. As shown in FIG. 18, the access right database 520 stores the user IDs and the corresponding unusable functions. When unusable functions are stored, for example, it is possible to make all the copy functions unusable, or to make only color copy function of the copy functions unusable. It should be noted that usable functions may be stored instead of storing unusable functions.

When the access right verifying section 507 receives a request to verify an access right of a user from any plug-in, the access right verifying section 507 determines the usable functions for the user based on the user ID stored in the user ID storage section 510 and the data stored in access right database 520 and sends the determined usable functions to the plug-in.

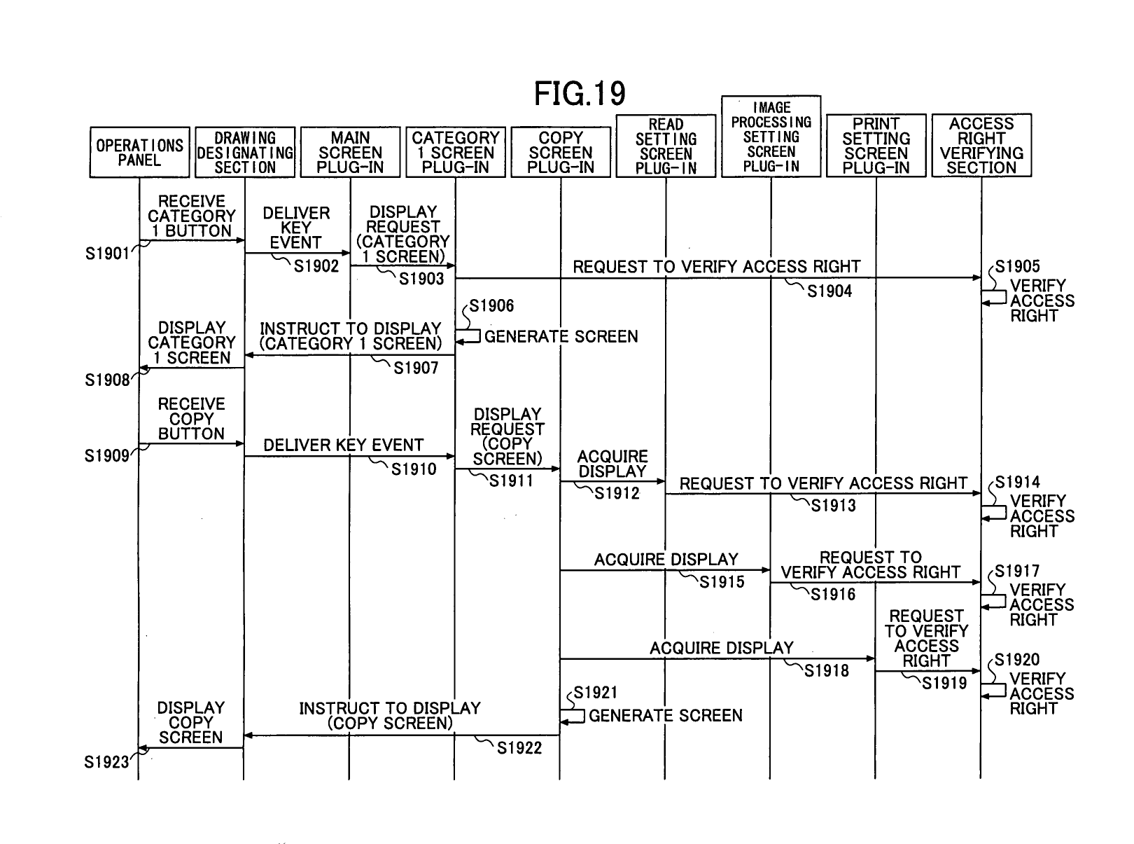

Next, an accessing process preformed by the MFP 500 according to the second embodiment of the present invention is described. FIG. 19 is a sequence diagram showing an operation of each section in an access right verification process. In this example, a case of displaying the main screen, a category 1 screen, and the copy screen are sequentially displayed is described.

The drawing designating section 102 receives a notice that the category 1 button on the main screen is selected (step S1901). Then, the drawing designating section 102 acquires the ID corresponding to the selected button. Further, the drawing designating section 102 delivers a key event to main screen plug-in 1061 (step S1902). The main screen plug-in 1061 sends a display request to the category 1 screen plug-in 1062 corresponding to the acquired ID in the main screen (step S1903).

The category 1 screen plug-in 1062 sends a request to the access right verifying section 507 to verify the access right (step S1904). The access right verifying section 507 determines the usable functions out of the registration information of the category 1 screen (step S1905). More specifically, the access right verifying section 507 determines whether each of the functions registered as the registration information of the category 1 screen is usable by the user ID stored in the user ID storage section 510. For example, when the registration information of the category 1 screen includes a “copy” function, a “scanner” function and a “FAX” function, and the “FAX” function is registered as the unusable function for the user ID “xxxx116”, it is determined that the usable functions of the user ID “xxxx116” are the “copy” function and the “scanner” function. The category 1 screen plug-in 1062 generates a category 1 screen in accordance with the access right verifying result by the access right verifying section 507 (step S1906). Namely, in this case, a menu screen in which the “FAX” function is unable to be selected is generated. As example of displaying manner of such a category 1 screen, only the “copy” button and the “scanner” button may be displayed, or a the “copy” button and the “scanner” button are normally displayed but the “FAX” button is displayed to be grayed-out.

The category 1 screen plug-in 1062 sends an instruction to the drawing designating section 102 to display the category 1 screen (step S1907). The drawing designating section 102 displays the category 1 screen on the operations panel 101 (step S1908).

The drawing designating section 102 receives a notice that the copy button on the category 1 screen is selected (step S1909). Then, the drawing designating section 102 acquires the ID corresponding to the selected button. Further, the drawing designating section 102 delivers a key event to category 1 screen plug-in 1062 (step S1910). The category 1 screen plug-in 1062 sends a display request to the copy screen plug-in 1065 corresponding to the acquired ID in the category 1 screen (step S1911). The copy screen plug-in 1065 starts the registered copy program. That is, the copy screen plug-in 1065 requests the read setting screen plug-in 1066 to acquire the read setting screen (step S1912).

The read setting screen plug-in 1066 sends a request to the access right verifying section 507 to verify the access right (step S1913). The access right verifying section 507 determines the usable function out of the functions of the read setting screen (step S1914). For example, when the user ID is “xxxx103” and, as shown in FIG. 18, “color settings” is set as the unusable function for the user ID “xxxx103”, it is determined that the functions of the read setting screen except the “color settings” function are usable by the user ID “xxxx103”.

Next, the copy screen plug-in 1065 requests the image processing setting screen plug-in 1067 to acquire the image processing setting screen (step S1915). The image processing setting screen plug-in 1067 sends a request to the access right verifying section 507 to verify the access right (step S1916). The access right verifying section 507 determines the usable function out of the functions of the image processing setting screen (step S1917). For example, when the user ID is “xxxx103” and, as shown in FIG. 18, “color settings” is set as the unusable function for the user ID “xxxx103”, it is determined that the functions of the image processing setting screen except the “color settings” function are usable by the user ID “xxxx103” if there is a “color settings” function in the image processing setting screen.

Next, the copy screen plug-in 1065 requests the print setting screen plug-in 1068 to acquire the print setting screen (step S1918). The print setting screen plug-in 1068 sends a request to the access right verifying section 507 to verify the access right (step S1919). The access right verifying section 507 determines the usable function out of the functions of the print setting screen (step S1920). For example, when the user ID is “xxxx103” and, as shown in FIG. 18, “color settings” is set as the unusable function for the user ID “xxxx103”, it is determined that the functions of the print setting screen except the “color settings” are usable by the user ID “xxxx103” if there is a “color settings” function in the print setting screen.

The copy screen plug-in 1065 generates the copy screen based on the acquired read setting screen, image processing setting screen, and print setting screen (step S1921). For example, when the user ID is “xxxx103”, in accordance with the verification result by the access right verifying section 507, the copy screen is generated based on the read setting screen, the image processing setting screen, and the print setting screen where the “color settings” function is unable to be selected in each of the screens. As a method of making a function unselectable, for example, the unselectable function may be deleted from the menu screen or displayed in gray-out. The copy screen plug-in 1065 sends a request to the drawing designating section 102 to display the copy screen (step S1922). The drawing designating section 102 displays the copy screen on the operations panel 101 (step S1923).

As described above, appropriate access right management can be realized without causing users to feel uncomfortable by verifying the access right to be displayed on a menu screen for each user when the menu screen is generated so that only usable functions for the user are displayed.

The present invention is not limited to the above first and second embodiments, and variations and modifications may be made without departing from the scope of the present invention. It should be noted that the configuration and/or elements described in above first and second embodiments can be arbitrarily combined without departing the scope of the present invention.

The present application is based on and claims the benefit of priority of Japanese Patent Application No. 2007-193446, filed on Jul. 25, 2007, the entire contents of which are hereby incorporated herein by reference.

What is claimed is:

1. An information processing apparatus comprising:
a function storage unit storing an identifier, a function program, and an image, the identifier representing a layout position of a menu screen where each function can be selected, the function program performing a prescribed function, the image representing a function executed by the function program, wherein the identifier, the function program, and the image are associated with each other;
an acquiring unit acquiring a pair of the function program and the image from the outside;
a registering unit associating a new identifier with the function program and the image each acquired by the acquiring unit and registering the identifier, the function, and the image into the function storage unit;
a generating unit generating a menu screen where the image stored in the function storage unit is laid out in accordance with the identifier associated with the image; and
a display unit displaying the menu screen generated by the generating unit.

2. The information processing apparatus according to claim 1, further comprising:
a receiving unit receiving the identifier associated with the image having been selected from the menu screen where the image is laid out; and
a starting unit starting the function program associated with the identifier received by the receiving unit, the function program being stored in the function storage unit.

3. The information processing apparatus according to claim 1, further comprising:
a layout order changing unit changing a layout order of the images laid out on the menu screen; and
a storage position changing unit changing the identifier associated with the function program and the image stored in the function storage unit in accordance with the layout order having been changed by the layout order changing unit.

4. The information processing apparatus according to claim 1, further comprising:
an access right storage unit storing user identification information identifying a user using the information processing apparatus and a function program unusable for the user, the user identification information and the function program being associated with each other; and
an access right verifying unit, upon receiving a request of access right verification from the generating unit, verifying an access right of the function program stored in the function storage unit based on the function program unusable for the user associated with the user identification information input and stored into the access right storage unit by the user; wherein
the generating unit generates a menu screen where the unusable function program out of plural of the function programs stored in the function storage unit is made unselectable in accordance with the verification result obtained by the access right verifying unit.

5. The information processing apparatus according to claim 4, wherein
the access right storage unit stores the user identification information and an unusable prescribed function out of the function programs, the user identification information and the unusable prescribed function being associated with each other;
the access right verifying unit, upon receiving a request of access right verification from the generating unit, verifies an access right of the prescribed function stored in the function storage unit based on the unusable prescribed function out of the function program associated with the user identification information input into the access right storage unit by the user; and
the generating unit generates a menu screen where the unusable prescribed function out of the function programs stored in the function storage unit is made unselectable in accordance with the verification result obtained by the access right verifying unit.

6. The information processing apparatus according to claim 1, wherein
a function setting screen generated by executing the function program can be commonly used by plural of the function programs.

7. The information processing apparatus according to claim 1, wherein
the function program can be partially or totally replaced by a newly installed function program.

8. A menu screen controlling method comprising:
an acquiring step of acquiring a pair of a function program and an image from the outside, the function program performing a prescribed function, the image representing a function executed by the function program;
a registering step of associating a new identifier with the function program and the image acquired in the acquiring step, the-identifier representing a layout position on a menu screen where each function can be selected, and registering the function program, the image, and the identifier into a function storage unit, wherein function program and the image are associated with the identifier;
a generating step of generating a menu screen where the image stored in the function storage unit is laid out in accordance with the identifier associated with the image; and
a displaying step of displaying the menu screen generated by the generating step.

9. The menu screen controlling method according to claim 8, further comprising:
a receiving step of receiving the identifier associated with the image having been selected from the menu screen where the image is laid out; and
a starting step of starting the function program associated with the identifier received in the receiving step, the function program being stored in the function storage unit.

10. The menu screen controlling method according to claim 8, further comprising:
a layout order changing step of changing a layout order of the images laid out on the menu screen; and
a storage position changing step of changing the identifier associated with the function program and the image stored in the function storage unit in accordance with the layout order having been changed in the layout order changing step.

11. The menu screen controlling method according to claim 8, further comprising:
an access right verifying step of, upon receiving a request of access right verification from the generating step, verifying an access right of the function program stored in the function storage unit based on the function program unusable for the user associated with the user identification information input and stored into an access right storage unit by the user, the access right storage unit storing user identification information identifying a user using the information processing apparatus and a function program unusable for the user, the user identification information and the function program being associated with each other, wherein
the generating step generates a menu screen where the unusable function program out of plural of the function programs stored in the function storage unit is made unselectable in accordance with the verification result obtained in the access right verifying step.

12. The menu screen controlling method according to claim 11, wherein
the access right verifying step, upon receiving a request of access right verification from the generating step, verifies an access right of the prescribed function stored in the function storage unit based on the unusable prescribed function out of the function program associated with the user identification information input into the access right storage unit by a user, the access right storage unit storing the user identification information identifying a user using the information processing apparatus and the unusable prescribed function out of plural of the function program, the user identification information and the unusable prescribed function being associated with each other; and
the generating step generates a menu screen where the unusable prescribed function out of the function programs stored in the function storage unit is made unselectable in accordance with the verification result obtained in the access right verifying step.

13. A menu screen controlling program causing a computer to execute the menu screen controlling method according to claim 8.
